(19) United States
(12) Patent Application Publication
(10) Pub. No.: US 2014/0136162 A1
(43) Pub. Date: May 15, 2014

(54) METHOD FOR SIMULATING FILMER COATING EFFICIENCY IN A PIPING NETWORK

(71) Applicant: GENERAL ELECTRIC COMPANY, Schenectady, NY (US)

(72) Inventors: Jayaprakash Sandhala Radhakrishnan, Bangalore (IN); Collin Wade Cross, Spring, TX (US); Manish Joshi, Bangalore (IN); Siva Kumar Kota, Bangalore (IN)

(73) Assignee: GENERAL ELECTRIC COMPANY, Schenectady, NY (US)

(21) Appl. No.: 13/676,723

(22) Filed: Nov. 14, 2012

(51) Int. Cl. G06F 17/50; G06F 7/60

(52) U.S. Cl. CPC G06F 17/5009; G06F 7/60
USPC 703/2

(57) ABSTRACT

Filmer coating efficiency may be simulated in a piping network with the aid of computational computer modeling.

### FIELD OF THE INVENTION

The present invention relates to the refinery processing of crude oil. Specifically, it is directed towards the problem of corrosion of refinery equipment caused by corrosive elements found in the crude oil.

### BACKGROUND OF THE INVENTION

Hydrocarbon feedstocks such as petroleum crudes, gas oil, etc., are subjected to various processes in order to isolate and separate different fractions of the feed stock. In refinery process, the feedstock is distilled so as to provide light hydrocarbons, gasoline, naphtha, kerosene, gas oil, etc.

The lower-boiling fractions are recovered as an overhead fraction from the distillation tower. The intermediate components are recovered as side cuts from the distillation tower. The various fractions are cooled, condensed, and sent to collecting equipment. No matter what type of petroleum feed stock is used as the charge, the distillation equipment is subjected to the corrosive activity of acids such as H₂S, HCl, organic acids, and H₂CO₃.

Corrosion in the crude overhead distillation equipment is mainly due to condensation of hydrogen chlorides formed by hydrolysis of the magnesium chloride and calcium chloride in crude oil. Typical hydrolysis reactions may proceed as in Equations I or II:

MgCl₂+2H₂O [symbol] 2HCl+Mg(OH)₂ (I)

CaCl₂+2H₂O [symbol] 2HCl+Ca(OH)₂ (II)

Corrosive attack on the metals normally used in the low temperature sections of a refinery (i.e., where water is present below its dew point) is an electrochemical reaction generally in the form of acid attack on active metals in accordance with Equations III, IV or V:

At the anode:

Fe [symbol] Fe⁺⁺+2e⁻ (III)

At the cathode:

2H⁺+2e⁻ [symbol] 2H (IV)

At the cathode:

2H [symbol] H₂ (V)

The aqueous phase may be water entrained in the hydrocarbons being processed and/or water added to the process for such purposes as steam stripping. Acidity of the condensed water is due to dissolved acids in the condensate, principally HCl, organic acids, H₂S, and H₂CO₃. HCl, the most troublesome corrosive material, is formed by hydrolysis of calcium and magnesium chlorides originally present in the brines.

One of the chief points of difficulty with respect to corrosion occurs above and in the temperature range of the initial condensation of water. The term “initial condensate” as it is used herein signifies a phase formed when the temperature of the surrounding environments reaches the dew point of water. At this point a mixture of liquid water, hydrocarbon, and vapor may be present. Such initial condensate may occur within the distillation tower itself or in subsequent condensers. The top temperature of the distillation tower is normally maintained above the dew point of water. The initial aqueous condensate formed contains a high percentage of HCl. Due to the high concentration of acids dissolved in the water, the pH of the first condensate is quite low. For this reason, the water is highly corrosive.

The common treatment strategy to mitigate corrosion is to inject chemicals, or corrosion inhibitors, into the overhead section that neutralize or deactivate the corroding species. Many types of corrosion inhibitors are suitable, and refiners typically use ammonia, an organic neutralizing amine, or a combination of the two. In a refinery context, these corrosion inhibitors are often referred to as “filmers” as they continuously replenish a thin film that forms a protective barrier between the corrosive species and the metal surface beneath the film. Filmers are typically injected at a rate of 3 to 5 ppm by volume of the crude oil stream, but these rates may vary widely with time and between refineries. A typical filmer composition used in a refinery is a solution of an alkylaminophosphate in liquid naphtha. Currently, injection designs are developed based on trial and error by people with experience in the field. This current method of developing injection designs of filmers is sub-optimal, leading to uneven coverage of pipe surfaces. This leads to severe corrosion of the exposed pipe surfaces, as witnessed in the field. The injection design must then be altered, often more than once, until corrosion is minimized. This trial and error process in inefficient and costly.

### BRIEF DESCRIPTION OF THE INVENTION

The present invention provides a methodology to assess the filmer injection design currently used in a given process and develop an optimum injection design, based on the operating conditions of that process. The methodology may also be used to design a new filmer injection system. This improves filmer coating efficiency, thereby leading to improved overall efficiency of a corrosion control treatment program.

The invention uses Computational Fluid Dynamics (“CFD”) to evaluate the coating efficiency of a given injection method, and determine the optimum injection strategy. CFD is a technique of numerically solving fluid mechanics and related phenomena in a fluid system.

In one embodiment, a method is disclosed wherein the filmer coating efficiency in a piping network is simulated for the purposes of optimizing the filmer coating efficiency. A multiphase CFD flow model may be developed using process parameters as inputs. The CFD model may be used to calculate a predicted filmer coating efficiency and generate a transfer function between the process parameters and predicted filmer coating efficiency. The transfer function may then be used to calculate outputs, including an optimized filmer coating efficiency and optimized process parameters to achieve the optimized filmer coating efficiency. The piping network may be a portion of a crude oil refinery and process parameters may include parameters such as piping parameters, distillation and equipment parameters, and fluid parameters. The filmer injection location and filmer injection type may also be used as inputs to the model. Various injection types like point, plane, line, etc may be analyzed. The inputs may also comprise filmer flow rate and filmer particle size distribution.

In yet another method embodiment, the process parameters may be changed to match the optimized process parameters calculated using the transfer function generated by the CFD model. The optimized process parameters may include filmer flow rate, filmer particle size distribution, and filmer injector type.

Systems for simulating filmer coating efficiency in a piping network for the purposes of optimizing the filmer coating efficiency are also disclosed. The systems may comprise a memory and a processor. The processor may be configured to receive inputs comprising process parameters; use the inputs to develop a multiphase CFD model; use the CFD model to calculate a predicted coating efficiency based on the inputs; generate a transfer function between the predicted coating efficiency and the inputs; use the transfer function to calculate an optimized coating efficiency and generate optimized process parameters to achieve the optimized coating efficiency. The processor may also be configured to store the optimized coating efficiency and optimized process parameters in the memory.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The below detailed description makes reference to the accompanying figures, in which:

FIG. 1 shows a simplified section of a hydrocarbon refining process.

FIG. 2A shows a section of piping leading to an overhead condenser.

FIG. 2B shows a closer view of the piping inlet.

FIG. 2C shows a closer view of the piping T-joint and outlet.

FIG. 3A shows the filmer liquid volume distribution in piping leading to an overhead condenser.

FIG. 3B shows a closer view of the filmer liquid volume distribution in the piping inlet.

FIG. 3C shows a closer view of the filmer liquid volume distribution in the piping T-joint and outlet.

FIG. 3D is a 3-dimensional view of the predicted volume fractions of the liquid at the T-joint using a 3-dimensional model.

FIG. 4 shows multiple views of the flow path of particles with a mean diameter of 100 μm.

FIG. 5 shows multiple views of the flow path of particles with a mean diameter of 200 μm.

FIG. 6 shows multiple views of the flow path of particles with a mean diameter of 300 μm.

FIG. 7 shows the percent coated area for a straight geometry as a function of particle diameter and liquid volume fraction.

FIG. 8A shows the mean path length when the injection point is located at 1 foot from the inlet elbow.

FIG. 8B shows the mean path length when the injection point is located at 2 feet from the inlet elbow.

FIG. 8C shows the mean path length when the injection point is located at 3 feet from the inlet elbow.

FIG. 9A shows the effect of particle size on liquid distribution at the T-joint.

FIG. 9B shows the effect of particle size on maximum liquid volume fraction in the piping.

FIG. 10 is a block diagram of an embodiment for optimizing filmer coating efficiency in a piping network with the aid of computational computer modeling.

### DETAILED DESCRIPTION OF EXEMPLARY EMBODIMENTS

The present invention provides a methodology to assess the filmer injection design currently used in a given process and develop an optimum injection design, based on the operating conditions of that process. The methodology may also be used to design a new filmer injection system. This improves filmer coating efficiency, thereby leading to improved overall efficiency of a corrosion control treatment program.

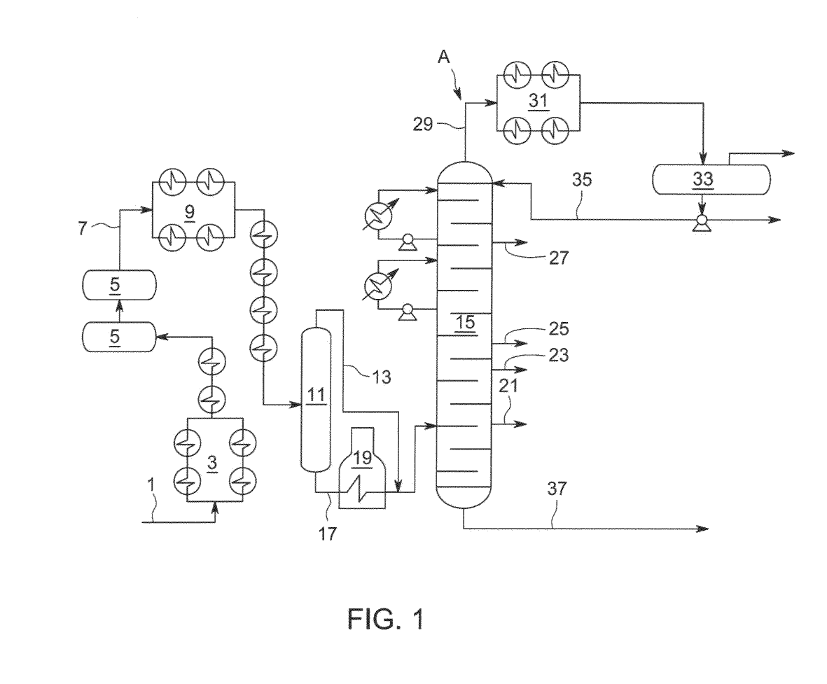

FIG. 1 (FIG. 1) shows a simplified section of a hydrocarbon refining process. Crude (1) is fed through a series of heat exchangers (3) before entering at least one desalter (5). Desalted crude (7) enters another series of heat exchangers (9) where it is preheated to about 200 to 700° F. before entering a flash drum (11), or preflash tower. The lights (13) from the flash drum may be fed directly to the distillation tower (15). The bottoms (17) from the flash drum may be fed to a direct-fired furnace (19) before they are fed to the distillation tower (15). The distillation tower is often called an atmospheric tower as it operates slightly above atmospheric pressure, typically around 1 to 3 atmospheres gauge.

The overhead distillation tower temperature usually ranges from 200 to 350° F. While in the tower, the crude is distilled into multiple fractions, also called “sidecuts.” The sidecuts comprise heavy gas oil (21), light gas oil (23), diesel (25), and kerosene (27). The bottoms (37) exit the distillation tower for processing elsewhere (not shown). Naphtha vapor (29) exits the top of the distillation tower and enters a series of heat exchangers (31). The naphtha vapor then enters at least one condenser (33). A portion of the condensed naphtha stream is fed back into the top of the tower as reflux (35).

Some refining processes may not utilize a flash drum and instead feed crude directly to a direct-fired furnace. Likewise some operations have been omitted from FIG. 1 for the sake of brevity. These and other minor differences in crude refining processes do not affect the scope of the invention.

The corrosion inhibitors, or filmers, may be injected into multiple points of a refining process. Filmers are typically injected into the piping at point (A) between the distillation tower (15) and the heat exchangers (31) or the condensers (33).

The invention uses Computational Fluid Dynamics (“CFD”) to evaluate the coating efficiency of a given injection method, and determine the optimum injection strategy. CFD is a technique of numerically solving fluid mechanics and related phenomena in a fluid system.

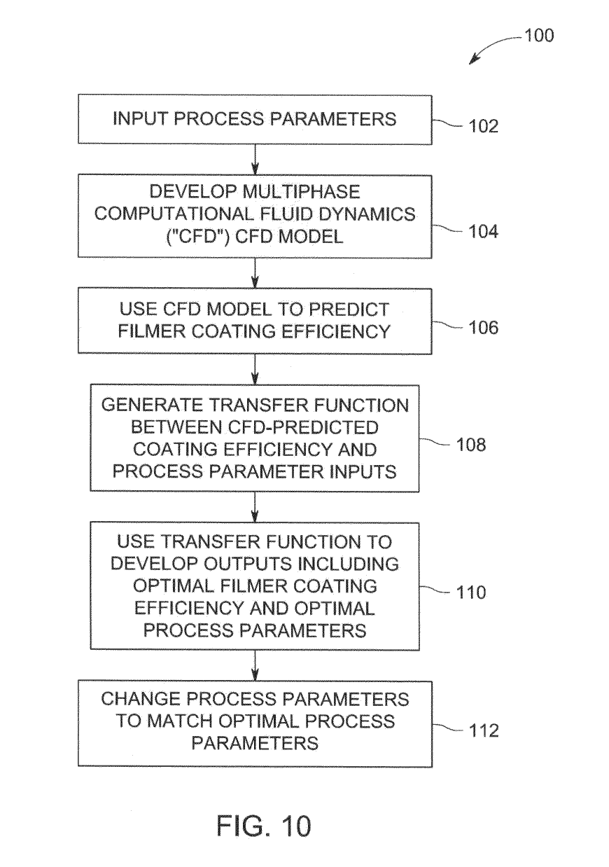

In one embodiment, a method is disclosed wherein the filmer coating efficiency in a piping network is simulated for the purposes of optimizing the filmer coating efficiency. Turning to FIG. 10, the method (100) may comprise inputting process parameters (102). A multiphase CFD flow model may be developed (104) using the inputted parameters. The CFD model may be used to calculate a predicted filmer coating efficiency (106) and generate a transfer function between the process parameters and predicted filmer coating efficiency (108). The transfer function may then be used to calculate outputs (110). The outputs may include, but are not limited to, an optimized filmer coating efficiency and optimized process parameters to achieve the optimized filmer coating efficiency. The piping network may be a portion of a crude oil refinery and process parameters may include parameters such as piping parameters, distillation and equipment parameters, and fluid parameters. The filmer injection location and filmer injection type may also be used as inputs to the model. Various injection types like point, plane, line, etc may be analyzed. The inputs may also comprise filmer flow rate and filmer particle size distribution.

In yet another method embodiment, the process parameters may be changed to match the optimized process parameters calculated using the transfer function generated by the CFD model (112). The optimized process parameters may include filmer flow rate, filmer particle size distribution, filmer injection type, and filmer injection location.

The invention is executable on a computer that includes a CPU, main storage, I/O resources and a user interface, such as a monitor and a manually operated keyboard and mouse. Optionally, the monitor may be a touch-screen. The computer may be a handheld device. Accordingly, systems for simulating filmer coating efficiency in a piping network for the purposes of optimizing the filmer coating efficiency are also disclosed. The systems may comprise a memory and a processor. The processor may be configured to receive inputs comprising process parameters; use the inputs to develop a multiphase CFD model; use the CFD model to calculate a predicted coating efficiency based on the inputs; generate a transfer function between the predicted coating efficiency and the inputs; use the transfer function to calculate an optimized coating efficiency and generate optimized process parameters to achieve the optimized coating efficiency. The processor may also be configured to store the optimized coating efficiency and optimized process parameters in the memory.

The user inputs various process parameters, such as the refinery overhead geometry and operating conditions. The invention then provides the user with information that allows the user to select an optimum injection strategy. Alternatively, this process may be automated by placing the computer or a PLC in direct communication with the refinery process components, hardware, or instrumentation via a wired or wireless network such that filmer injection parameters may be optimized as refinery parameters change. A corrosion monitor may be placed at one or more locations in the piping to provide additional inputs on pipe corrosion to the CFD flow model and aid in model accuracy. Suitable corrosion monitors include, but are not limited to, ultrasound, X-Ray, or resistance-based monitors, such as the Predator® Resistance Corrosion Monitor (General Electric, Trevose, Pa.).

In one embodiment, a multiphase CFD flow model may be developed and simplified using any series of suitable modular parts. The modular parts may be separated by pipe geometry. For example, the modular parts may be separated into components corresponding to piping components such as straight pipe, bends, reducers, and T-joints. Process parameters may be included in the model. Process parameters may include any parameter from the distillation process thought to be relevant to the coating efficiency, including, but not limited to, piping parameters, distillation and equipment parameters, and fluid parameters. Piping parameters include pipe geometry, pipe material, and interior surface roughness. More specifically, pipe geometry may include pipe dimensions such as length, diameter, and the shape of the various piping components. For piping components including bends, bend dimensions, such as the degree of bend and arc length may be included. Distillation parameters may also be considered, such as temperatures, pressures, distillate viscosity, density, and flow rates, and observed corrosion rates. Fluid parameters of the film may also be considered, such as filmer viscosity, flow rate, fluid phase, and particle size. Equipment parameters, such as injection quill type may also be considered. Additional process parameters such as location and type of injection may also be used as inputs to the model. Various injection types like point, plane, line, etc may be analyzed. CFD model may be a 2-dimensional model or a 3-dimensional model.

In another embodiment, the CFD model may be further simplified through the use of non-dimensional variables, such as Reynolds number and relative roughness. The Reynolds number may be expressed as:

$$\frac{ρ vD}{μ} = Re , Reynold ' s number$$

where ρ is the fluid density, ν is the average fluid velocity (defined as the volumetric rate of flow divided by the cross-sectional area of the pipe), D is the inside pipe diameter, and μ is the fluid viscosity.
The relative roughness may be expressed as:

ε/D=relative roughness

where ε is a roughness parameter (defined as the average height, m, of roughness projections from the wall).

A transfer function is generated between the filmer coating efficiency that is predicted by CFD and the mentioned inputs. This transfer function is used to assess the efficiency of a given injection system and also used to select an optimum injection strategy. Once a strategy is selected, the process parameters, such as filmer flow rate and particle size, may be adjusted to match the optimum injection strategy.

Filmer coating efficiency is a measure of amount of filmer actually injected into the system to effectively coat the piping components expressed as a percentage of the theoretical amount required to effectively coat the piping components. The filmer coating efficiency (“FCE”) may be computed as:

$$FCE = ( \frac{{A}_{a}}{{A}_{t}} ) \times 100 \%$$

where A_{α} is the actual area of the pipe that is coated with the filmer (m²), and Aₜ is the total internal surface area of the pipe. A_{α} is calculated from the CFD model and Aₜ is calculated from the pipe geometry.

### EXAMPLES

For the examples, a multiphase simulation and a discrete particle tracking simulation were performed using a Computational Fluid Dynamics (“CFD”) model. The system used was a HP Work station Z400 computer using FLUENT® 6.3.26 software (ANSYS, Inc. Canonsburg, Pa.). The inlet gas velocity of the filmer for both simulations was 12 m/s (40 fps). Both 2-dimentional and 3-dimentional CFD models were used.

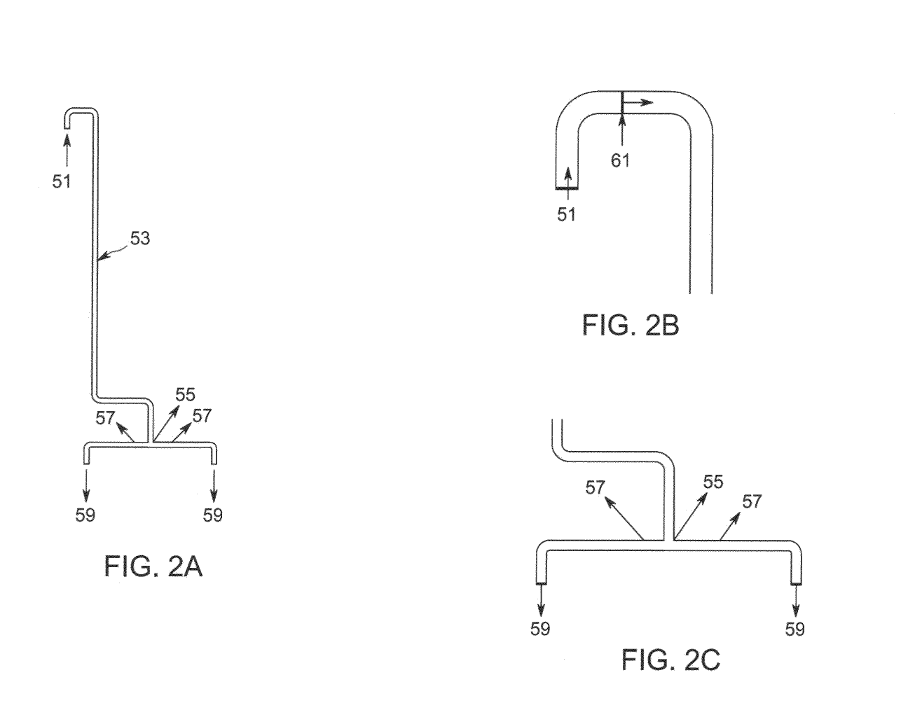

FIG. 2A shows a detailed view of the piping geometry used in the simulations for the examples. The piping of FIG. 2A is an embodiment of piping to an overhead condenser. The filmer is injected into the inlet of the pipe (51). The inlet is a goose neck connected to vertical length of pipe (53). The vertical length of pipe terminates in a T-joint (55). Before terminating in the T-joint, the vertical length of pipe is connected to two 90° elbows in series. The T-joint has a pair of reducers on either side (57) connected to the outlets (59) to the condensers. The diameter of all the piping from the inlet to the reducers is 16 inches. The diameter of the piping after the reducers to the outlet is 10 inches. The total length of the piping from the inlet to the outlet is about 150 feet (43 meters). FIG. 2B is a closer view of the piping inlet (51) and shows a filmer injection plane (61). FIG. 2C is a closer view of the T-joint (55), the reducers (57) and the outlets (59) to the condensers.

Ideally, the filmer coats all the inner surfaces of the piping, including the length of the vertical pipe (53) and the outlets (59) to the condensers.

### Example 1

A gas and liquid naphtha system was modeled for the multiphase flow simulation of the filmer. The simulation included the bulk phases comprising naphtha distillate. The inlet liquid volume fraction of the filmer was 1%. The droplet mean diameter was 100 μm. Although in practice, the filmer is injected continually (steady state), a pulse injection (unsteady state) was used to simulate the filmer injection. A pulse time of 40 seconds was simulated.

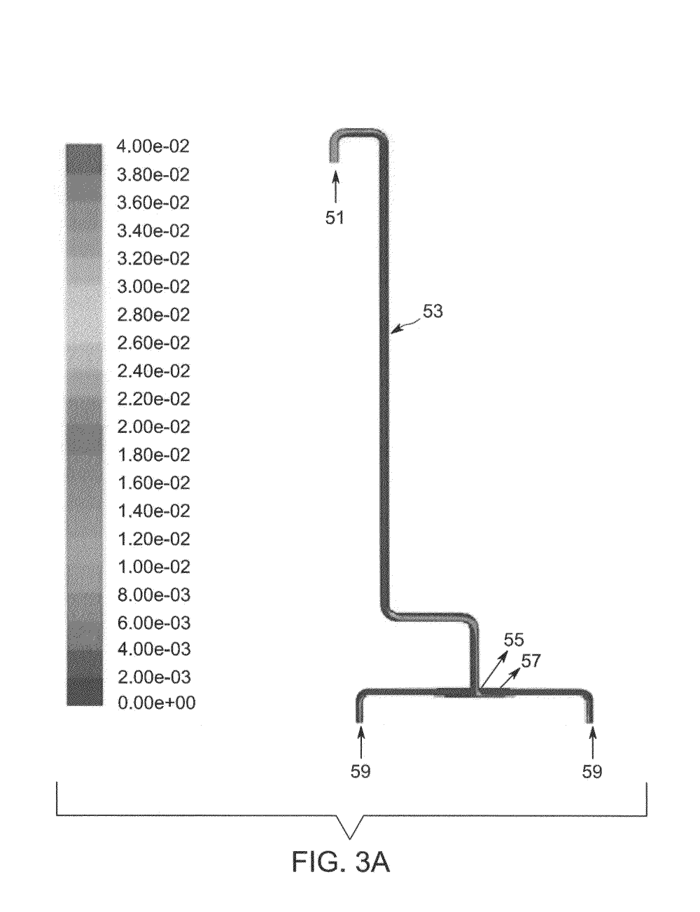

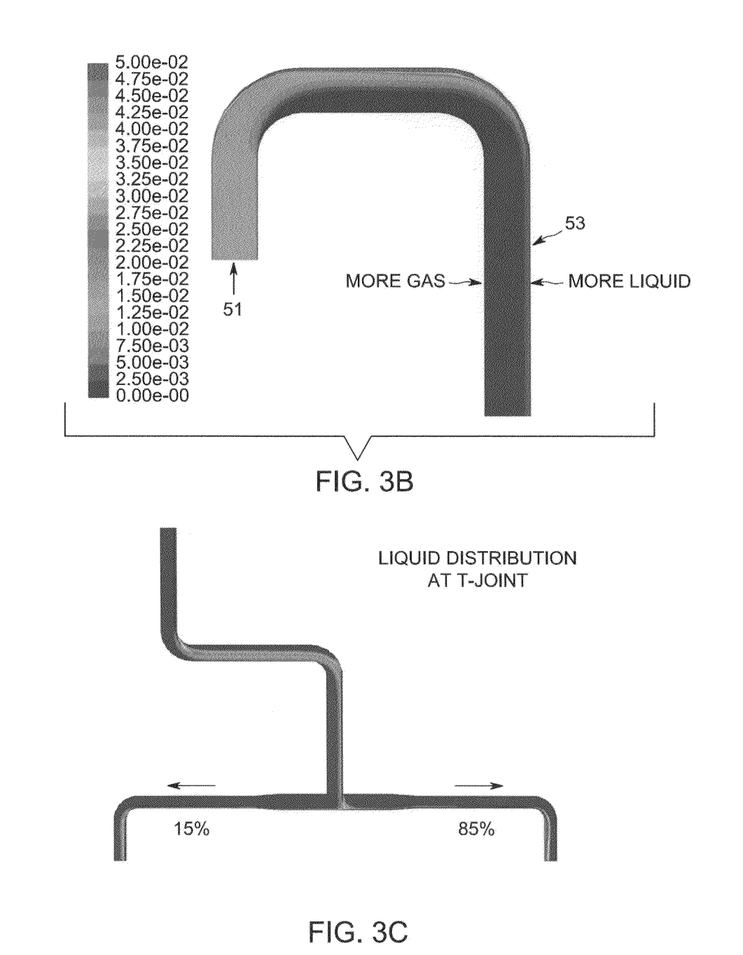

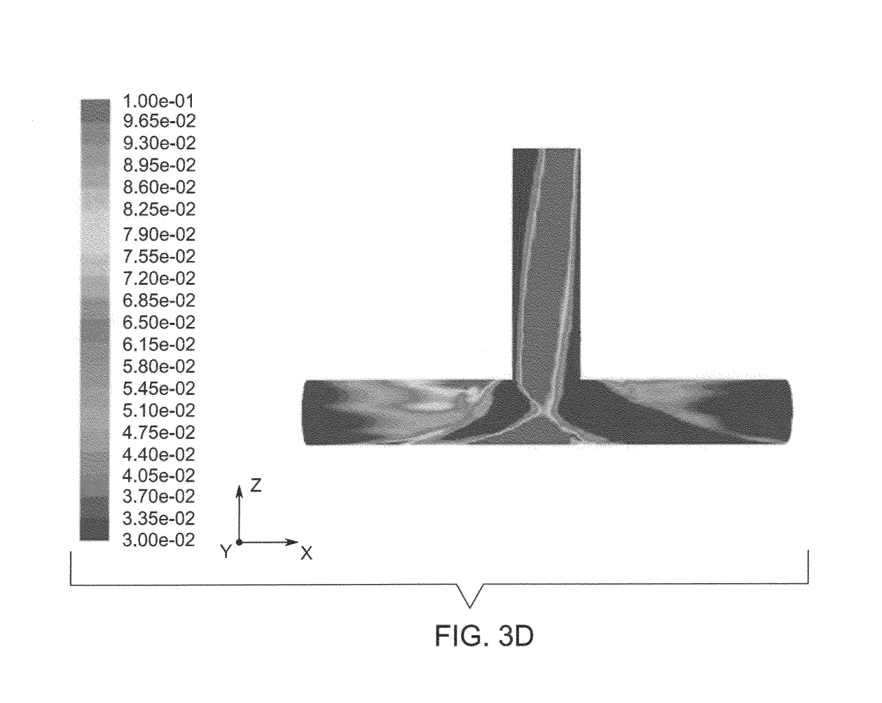

FIG. 3A shows the simulation results for the piping to an overhead condenser shown in FIG. 2A using a 2-dimentional CFD model. The color contours show the predicted volume fractions of the liquid. Volume fractions greater than about 1.40×10⁻⁰² (green to red contours) are liquids, and volume fractions less than about 1.40×10⁻⁰² (blue) are gases. FIG. 3B is a closer view of the piping inlet (51) showing the volume fractions in the goose neck. FIG. 3C is a closer view of the volume fractions in the T-joint (55), reducers (57), and outlets (59). FIG. 3D is a 3-dimensional view of the predicted volume fractions of the liquid at the T-joint using a 3-dimentional CFD model. As can be seen in FIG. 3A-3D, the pipe geometry influences the liquid distribution. More liquid covers the right wall of the vertical pipe (53) and at the T-joint (55); about 85% of the liquid enters the right T. Injection into the vertical section of the pipe enhances filmer coverage as shown in Example 4.

### Example 2

For the discrete particle tracking simulation, the flow path of individual liquid drops, or particles, was simulated. The simulations were repeated for particle mean diameters of 100 μm, 200 μm, and 300 μm. It was assumed the particles had a particle diameter distribution. The simulation “tracked” the particles from the injection surface through the piping to the outlets to the condensers.

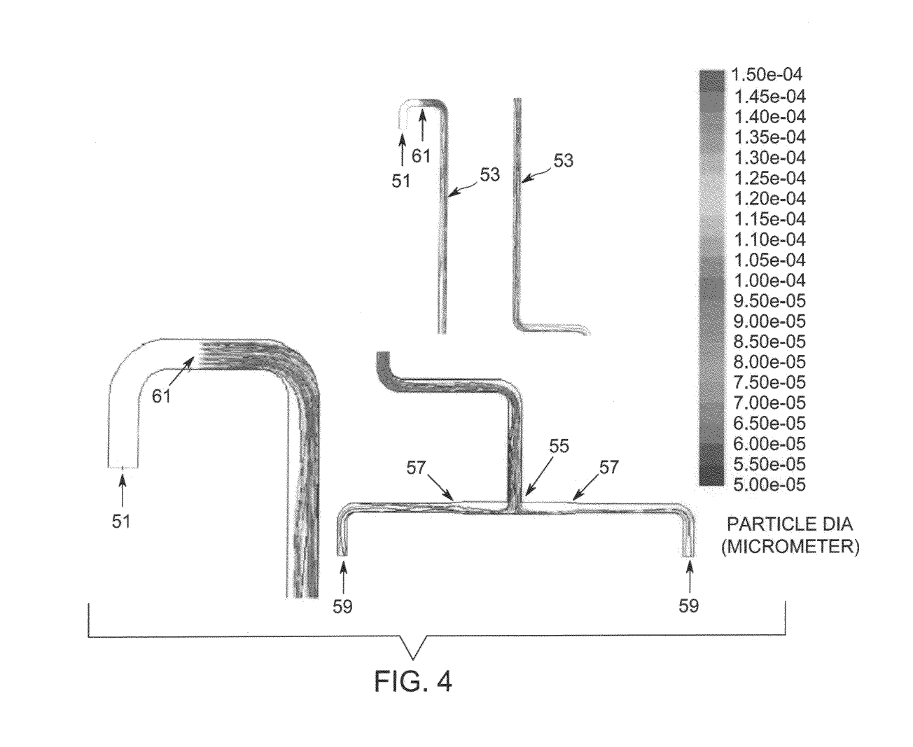

FIG. 4 shows multiple views of the flow path of particles with a mean diameter of 100 μm (green). The contours show the flow paths for the particles of various diameters within the assumed particle diameter distribution range of 50 μm (blue) to 150 μm (red).

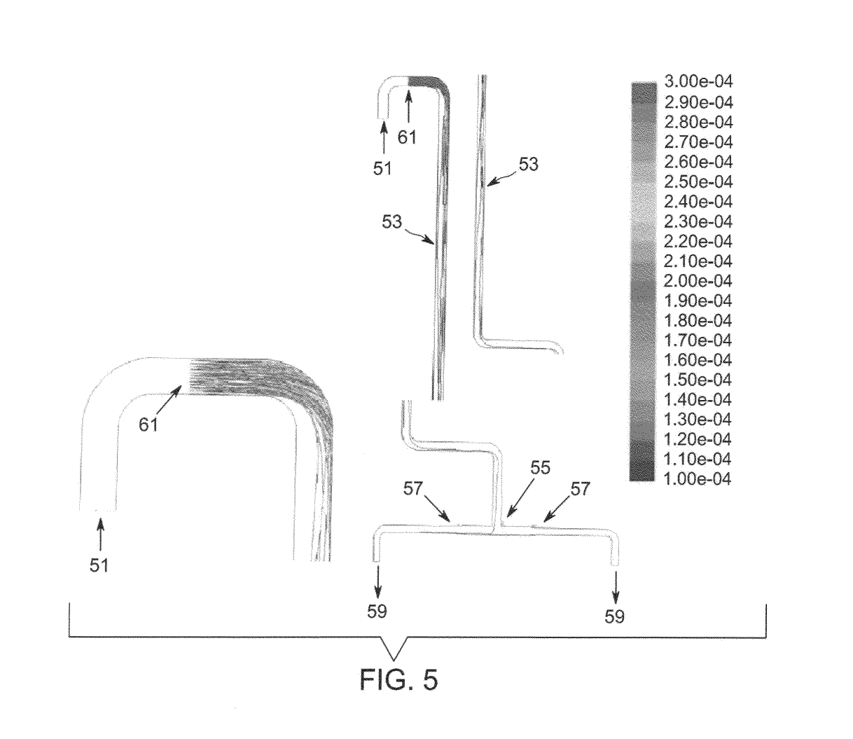

FIG. 5 shows multiple views of the flow path of particles with a mean diameter of 200 μm (green). The contours show the flow paths for the particles of various diameters within the assumed particle diameter distribution range of 100 μm (blue) to 300 μm (red).

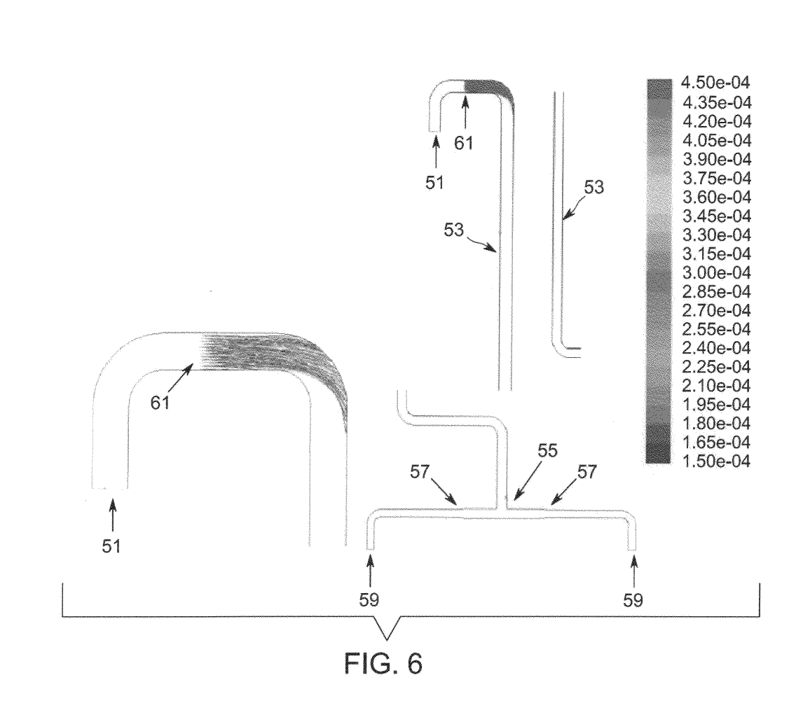

FIG. 6 shows multiple views of the flow path of particles with a mean diameter of 300 μm (green). The contours show the flow paths for the particles of various diameters within the assumed particle diameter distribution range of 150 μm (blue) to 450 μm (red).

### Example 3

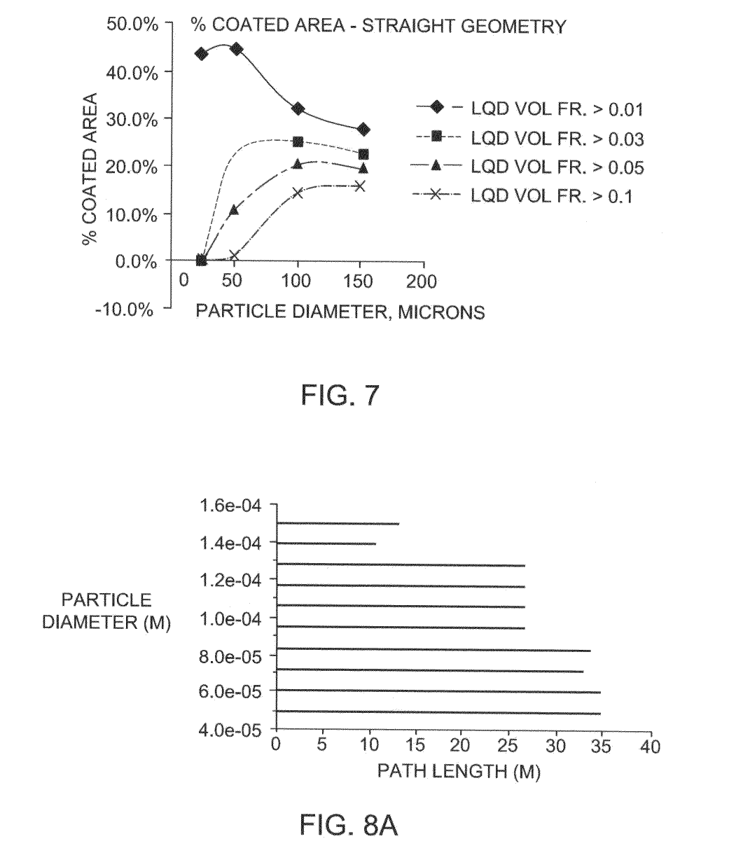

For Example 3, FIG. 7 shows the percent coated area for a straight geometry, where the inlet pipe is in the same plane as the outlet section, as a function of particle diameter (microns) and liquid volume fraction (“Lqd Vol fr.”).

### Example 4

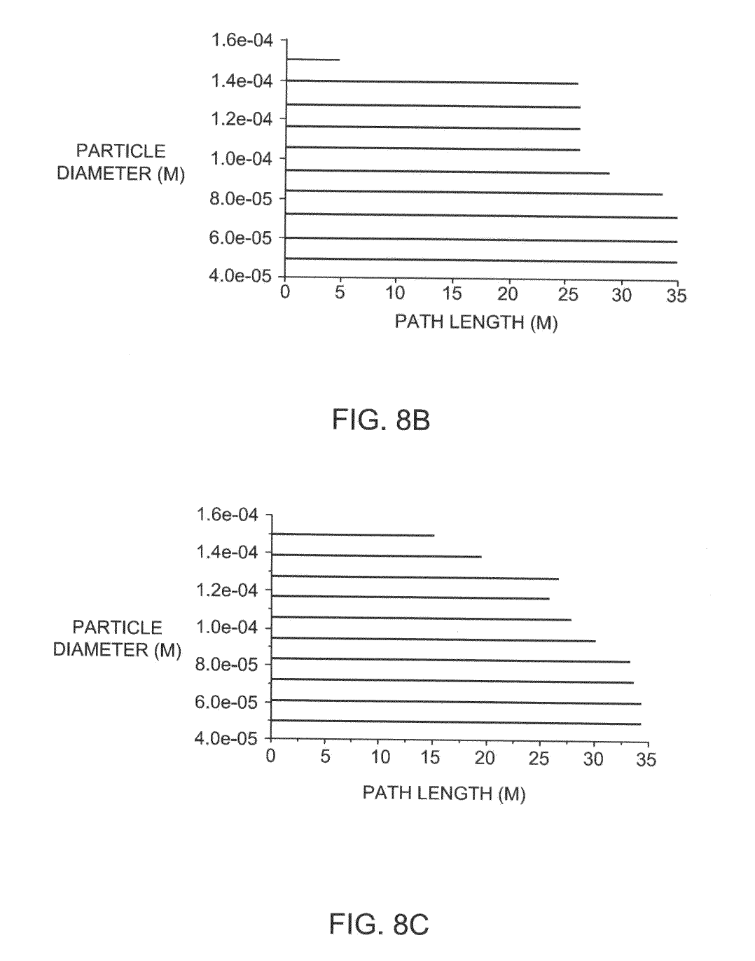

For Example 4, a 3-dimentional CFD model was used to evaluate the effect of filmer injection point on mean path length for particles of various diameters ranging from about 50 μm to about 150 μm. FIG. 8A shows the mean path length when the injection point is located at 1 foot from the inlet elbow. FIG. 8B shows the mean path length when the injection point is located at 2 feet from the inlet elbow. FIG. 8C shows the mean path length when the injection point is located at 3 feet from the inlet elbow.

### Example 5

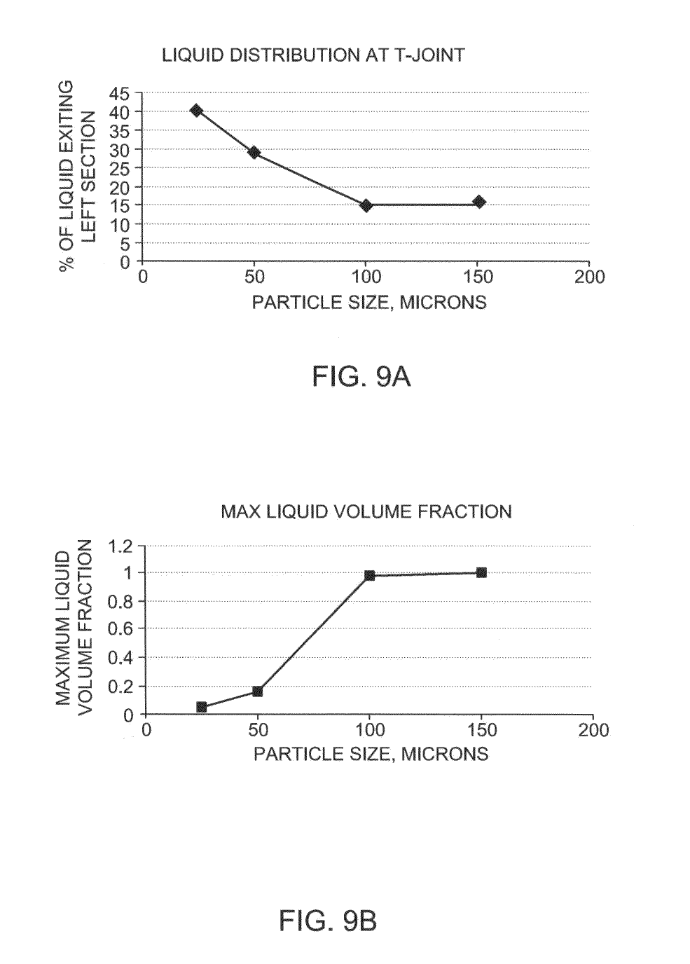

For Example 5, the effects of particle size on the liquid distribution and liquid volume fraction were evaluated using a 3-dimentional model. FIG. 9A shows the effect of particle size on liquid distribution at the T-joint. FIG. 9B shows the effect of particle size on maximum liquid volume fraction in the piping.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of simulating filmer coating efficiency in a piping network for the purposes of optimizing said filmer coating efficiency, said method comprising:
receiving inputs, said inputs comprising process parameters;
using said process parameters to develop a multiphase computational fluid dynamics (“CFD”) model;
using said CFD model to calculate a predicted filmer coating efficiency based on said inputs;
generating a transfer function between said predicted coating efficiency and said inputs; and
using said transfer function to calculate outputs, said outputs comprising an optimized filmer coating efficiency and optimized process parameters to achieve said optimized filmer coating efficiency.

2. The method of claim 1, wherein said piping network is a portion of a crude oil refinery.

3. The method of claim 1, wherein said inputs comprise piping parameters, distillation and equipment parameters, and fluid parameters.

4. The method of claim 3, wherein said inputs further comprise, filmer flow rate, filmer particle size distribution, filmer injection location, and filmer injection type.

5. The method of claim 1, wherein said optimized process parameters comprise filmer flow rate, filmer particle size distribution, filmer injection location, and filmer injection type.

6. The method of claim 1, further comprising the steps of changing said process parameters to said optimized process parameters.

7. A system for simulating filmer coating efficiency in a piping network for the purposes of optimizing said filmer coating efficiency, said system comprising:
a memory; and
a processor operatively connected with said memory, where said processor is configured to:
receive inputs, said inputs comprising process parameters;
use said inputs to develop a multiphase computational fluid dynamics (“CFD”) model;
use said CFD model to calculate a predicted filmer coating efficiency based on said inputs;
generate a transfer function between said predicted coating efficiency and said inputs;
use said transfer function to calculate outputs, said outputs comprising an optimized filmer coating efficiency and optimized process parameters to achieve said optimized filmer coating efficiency; and
store said transfer function, said optimized filmer coating efficiency and said optimized process parameters in said memory.

8. The system of claim 7, wherein said inputs comprise piping parameters, distillation and equipment parameters, and fluid parameters.

9. The system of claim 8, wherein said inputs further comprise filmer flow rate, filmer particle size distribution, filmer injection location, and filmer injection type.

10. The system of claim 7, wherein said optimized process parameters comprise filmer flow rate, filmer particle size distribution, filmer injection location, and filmer injection type.
